(19) United States
(12) Patent Application Publication
(10) Pub. No.: US 2022/0323289 A1
(43) Pub. Date: Oct. 13, 2022

(54) FITNESS, EXERCISE AND MASSAGE ROLLER

(71) Applicant: Arttu Suokas, Helsinki (FI)

(72) Inventor: Arttu Suokas, Helsinki (FI)

(21) Appl. No.: 17/679,586

(22) Filed: Feb. 24, 2022

(30) Foreign Application Priority Data
Apr. 9, 2021 (EP) 21167539.2

(51) Int. Cl. A61H 15/00; A63B 17/04

(52) U.S. Cl. CPC A61H 15/0092; A63B 17/04; A61H 2015/0014; A61H 2201/0119; A61H 2201/1284

(57) ABSTRACT

The invention relates to a fitness, exercise and massage roller, which roller (10) has a substantially cylindrical shape and a hollow opening (13) around its imaginary center axis, which roller (10) comprises two or more frame parts (11,12), which are at least part-circular in their outer form and configured to form the cylindrical shape of the roller (10). At least one of the frame elements (11, 12) is separable or turnable from connection with the other frame elements (11, 12) such, that a longitudinal opening is formed and that the roller (10) is configured to be located around a bar (51) or like via the longitudinal opening. The roller (10) comprises adjusting rotation elements (15) located in the hollow opening (13) and configured to provide rotatable and adjustable fastening of the roller (10) around the bar (51) or like and the adjusting rotation elements (15) are configured to adjust or self/auto-adjust cross-sectional inner dimensions of the hollow opening (13) to correspond to cross-sectional outer dimensions of the bar (51).

### TECHNICAL FIELD

The present invention relates to fitness, exercise and massage rollers. More precisely the present invention relates to a fitness, exercise and massage roller according to the preamble part of claim 1.

### BACKGROUND

It is known from prior art to use fitness, exercise and massage rollers for relieving the tightness muscles and treatment of fasciae. The fitness, exercise and massage rollers are also used in different types of muscles and fasciae treatments of active, passive and other persons having need for the corresponding treatment. These rollers are generally made of plastic, foam, or rubber and the rollers currently on the market can have a smooth or a textured surface. One type of massage devices is the fitness, exercise and massage roller, often called as foam roller, which is often used by placing the roller below the body part needing massage and rolling the body part against the roller and the body weight creating thus the massage force. The foam rollers are used in different types of exercises and are typically solid foam structures with a smooth surface or with a surface with different types of protrusions. The surface structure of different types of foam rollers may be produced of different hardness values depending on desired results and/or on types of use. Foam rollers are most typically used on a floor such that desired body part of a user is placed on the foam roller located on the floor. The user shifts his/her weight on the foam roller and performs longitudinal or transversal movements creating a massage effect. In some applications the foam roller may be raised up from the floor in case selected exercise can be performed better when the foam roller is in raised position.

In patent application publication EP 3574885 A1 is disclosed a portable massage and storage device comprising a rigid outer container fully enclosing a hollow interior and extending along a longitudinal axis from a first end to a second end, the container being formed of a top shell and a mating bottom shell, each shell comprising a concave main shell section extending in a peripheral direction from a longitudinal front edge to a longitudinal rear edge, wherein the two shells are hingedly connected so that the they can be pivoted relative to each other from a closed position, in which the front edges and the rear edges abut each other, to an open position, and the container further comprises locking elements that are releasably engageable with one another for securing the container in the closed position. The two shells thus enclose the hollow interior of the container, which is configured for storage of personal items.

In patent application US 2018326254 A1 is disclosed an exercise foam roller comprising a plurality of elongated tube sectors, each having first and second longitudinal edges, an outer surface and foam covering at least a portion of the outer surface, means for interconnecting the tube sectors along their first longitudinal edges, means for detachably interconnecting the tube sectors along their second longitudinal edges, providing access to the interior of the roller for storage of such items as exercise floor mats.

In patent application US 2019142688 A1 is disclosed an exercise and massage apparatus, comprising: first cylindrical member having two end portions and an interposing central portion which is rotatable relative to each of the end portions, wherein the first cylindrical member is operable as a first muscle massage device; a second cylindrical member having a central bore adapted to receive the first cylindrical member; and a releasable catch member adapted to laterally constrain the second cylindrical member at a central region of the first cylindrical member while the two end portions of the first cylindrical member are exposed to permit the exercise and massage apparatus to be operable as at least one of a second muscle massage device and an abdominal exercise device.

EP 3656365 A1 is disclosed a massage roller, which is modularly built of circumferential elements such, that inside a hollow space is formed. In design publication USD 822772 is disclosed a portable roller built of circumferential elements such, that inside a hollow space is formed.

In patent application publication US 2017080283 A1 is disclosed a non-openable foam roller comprising hollowed-out core allowing insertion of a mechanical core comprised of a pair of bearings, a PVC-pipe and a steel tube that allow the mechanical foam rollers cylinder shape to perform work in a multi-angled circular rotation. In patent application publication CN 106377887 A1 is also disclosed a non-openable roller with hollow core.

In utility model publication DE 202015100830 U1 is disclosed a training device comprising a frame with a, in vertical direction movable, horizontal tube around which a foam roller is arranged as padding. In patent application publication US 2016129302 A1 is disclosed an exercise device, comprising a hollow cylindrical roller, two end plates fixable to the opposite ends of said roller, the inner envelope of the roller and the end plates essentially defining a cavity and each of the end plates further comprising essentially centrally situated bearing arrangement, two supporting feet each having a first and a second support.

One objective is further to create an improved fitness, exercise and massage roller, in which the above described problems and disadvantages relating to known fitness, exercise and massage rollers are eliminated or at least minimized.

One objective of the present invention is to provide an improved fitness, exercise and massage roller, which is easily and safely attachable on an existing bar or like without unmounting the bar or like.

One objective of the present invention is to provide an improved fitness, exercise and massage roller, which is adjustable or self-adjusting on bar or likes of different diameters and/or forms.

One objective of the present invention is to provide an improved fitness, exercise and massage roller, which rolls smoothly on bar or likes.

### SUMMARY

In order to achieve the above objects and those that will come apparent later the fitness, exercise and massage roller is mainly characterized by the features of the characterizing part of claim 1.

Dependent claims present advantageous features and embodiments of the invention.

According to an advantageous aspect of the invention the fitness, exercise and massage roller is fastenable around a bar or like without need of releasing the bar from its supports or of opening the bar or dismantling it to parts. The fitness, exercise and massage roller comprises adjusting rotation elements configured to provide rotatable and adjustable fastening of the roller around the bar or like. The adjusting rotation elements are configured to adjust or self/auto-adjust cross-sectional inner dimensions of the hollow opening around imaginary center axis of the roller to outer dimensions of cross-section of the bar such, that the roller is fastened securely around the bar or like and rotates smoothly around the bar or like irrespective of outer dimensions and/or cross-sectional shape of the bar or like.

According to an advantageous aspect of the invention the fitness, exercise and massage roller comprises an openable mechanism—a locking mechanism—configured to provide easy and secure locking of the roller.

According to an advantageous aspect of the invention the adjusting rotation element is mounted on a wall element in an element recesses of the hollow opening of the roller.

According to an advantageous aspect of the invention innermost surface of the adjusting rotation element is a sliding joint constructed in an angle to provide at least two centering contact points to the bar or like and configured to provide rotational movement of the roller around the bar or like for use.

According to an advantageous aspect of the invention outermost part of the adjusting rotation element is formed to make a stabile fit with staggered openings formed on the wall element and by placing the adjusting rotation elements to different openings of the wall elements for adjusting the cross-sectional dimensions of the hollow opening to correspond to the cross-sectional dimension of the bar or like around which the roller is to be placed for use.

According to an advantageous aspect of the invention the adjusting rotation elements may comprise a ring/-s, a wheel/-s, a bearing/-s, a roll/-s, a slip joint/-s or a combination of these.

According to an advantageous aspect of the invention the ring/-s, the wheel/-s, the bearing/-s, the roll/-s, the slip joint/-s or the combination of these in the adjusting rotation elements can directly contact the bar, whereby the rotating movement is provided between the ring/-s, the wheel/-s, the bearing/-s, the roll/-s, the slip joint/-s or the combination of these and the bar.

According to an advantageous aspect of the invention the ring/-s, the wheel/-s, the bearing/-s, the roll/-s, the slip joint/-s or the combination of these in the adjusting rotation elements are located inside the roller structure, whereby innermost structure/-s of the roller is fastened non-movably around the bar and the rotating movement is provided between the ring/-s, the wheel/-s, the bearing/-s, the roll/-s, the slip joint/-s or the combination of these and inner structures of the roller.

According to an advantageous aspect of the invention the adjusting rotation element may comprise a brake mechanism, whereby resistance can be provided to the rotating movement of the roller.

According to an advantageous aspect of the invention the adjusting rotation element is automatically adjustable, self-adjusting, or manually adjustable around bars or like with different cross-sectional dimensions, for example diameters of 10-50 mm. Adjusting rotation elements may comprise a spring/-s, an adjustment screw/-s, an adjustment latch/-es, a clamp/-s, a tension string/-s, an adjustment piece/-s and/or staggered openings.

According to an advantageous aspect of the invention the fitness, exercise and massage roller is configured to be fastened around the bar or like by first opening the roller by separating from each other at least two cylindrical segments of the roller. The opening may be provided by a hinge mechanism or by releasing one or more cylindrical segments from the roller by releasing the fastening, for example a pin mounting, between them or by opening a hatch of the roller or through an opening, for example a spiral opening of the roller. According to an advantageous aspect of the invention the fitness, exercise and massage roller may comprise at least one hinge, which may be of hard material, such as hard plastic or metal. Advantageously, the hinge is formed of hinge structures formed on the frame parts and are hinged with a hinge axis through holes of the hinge structures formed on the frame parts. Advantageously, the hinge can also be a spring hinge or is made of elastic material, for example of leather or of elastomer.

According to an advantageous aspect of the invention the fitness, exercise and massage roller may comprise at least one locking mechanism, for example an adjustable latch lock/-s, a clamp/-s, a tension string/-s or magnet/-s, by which the roller is fastened securely and safely around the bar or like.

The fitness, exercise and massage roller according to the invention can be fastened around bars of different cross-sectional sizes and different cross-sectional shapes (round, elliptic, angular etc.) to a around its longitudinal axis rotatable position. By the openable structure of the cylindrical body of the fitness, exercise and massage roller is provided easy fastening without the need of pushing the fitness, exercise and massage roller through its end around the bar and/or sliding the fitness, exercise and massage roller along the bar, or without needing to remove the bar from its supports, which provides the possibility of using the fitness, exercise and massage roller also in connection with fixed bars. The fitness, exercise and massage roller according to the invention provides for possibility of variable usages of the fitness, exercise and massage roller for different usages, for example massage of muscles, different types of exercise work out and treatment of fasciae, as well as for the possibilities of variable usages for different purposes for example rolling, Pilates exercising, stretching, massaging, pre-warming the muscles etc. Additionally, the fitness, exercise and massage roller according to the invention provides for possibility of positioning the fitness, exercise and massage roller at desired height utilizing already existing bar-type supports of different frames, frameworks etc. The bar-type supports, typically horizontal, may be for example barbells, gym-racks, pull-up-bars, stall-bars and like, which provide safe fastening and typically are provided in gyms, health clubs, fitness clubs and like. For example the barbells often have end parts for attachment of weights, which end parts typically have a greater diameter than middle part of the barbell, and thus the invention is very advantageous as the diameter of the hollow opening can first be adjusted to pass through the thicker end part and then adjusted to the dimensions of the middle part for the fitness, exercise or massage.

By the fitness, exercise and massage roller according to the invention and its advantageous features many advantages are achieved: The benefit of the fitness, exercise and massage roller according to the invention is also the possibility of easy variation of the position of the fitness, exercise and massage roller during the treatment and/or exercise when needed. The openable mechanism provides the possibility of using already existing bars and like. The adjusting rotation elements provide smooth rotation around the bar or like and by the adjustability the roller can be used in connection with bars and like with different dimensions and profiles.

### BRIEF DESCRIPTION OF THE DRAWINGS

In the following the invention and its advantages are explained in greater detail below in the sense of example and with reference to accompanying drawing, where

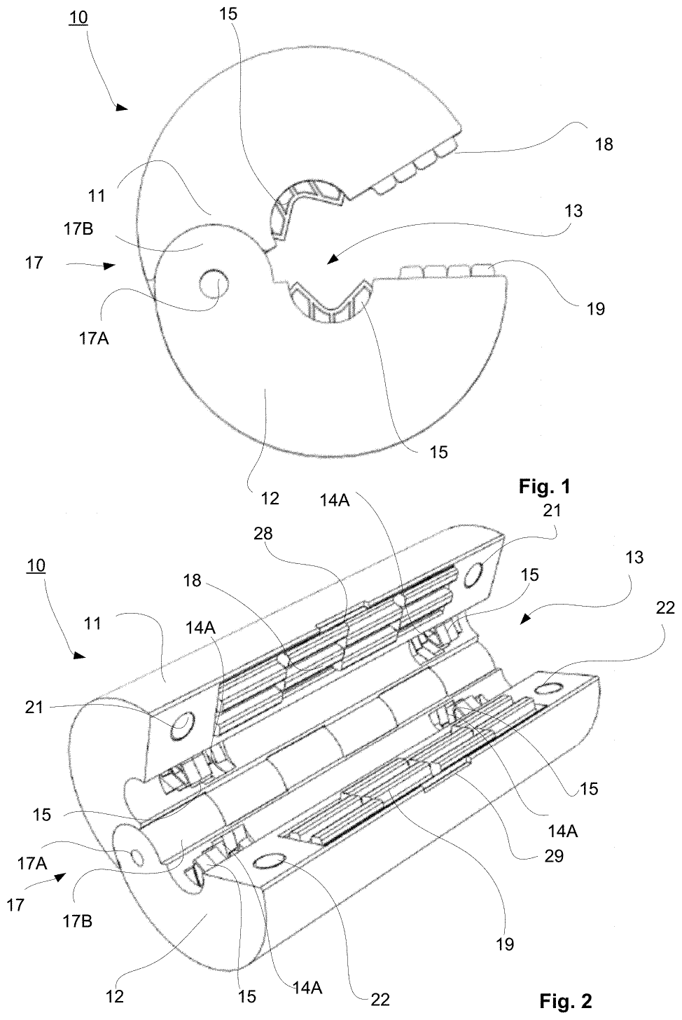

In FIG. 1 is schematically shown an advantageous example of a fitness, exercise and massage roller as an end view, the roller in opened position.

In FIG. 2 is schematically shown the advantageous example of FIG. 1 as a 3D view, the roller in opened position.

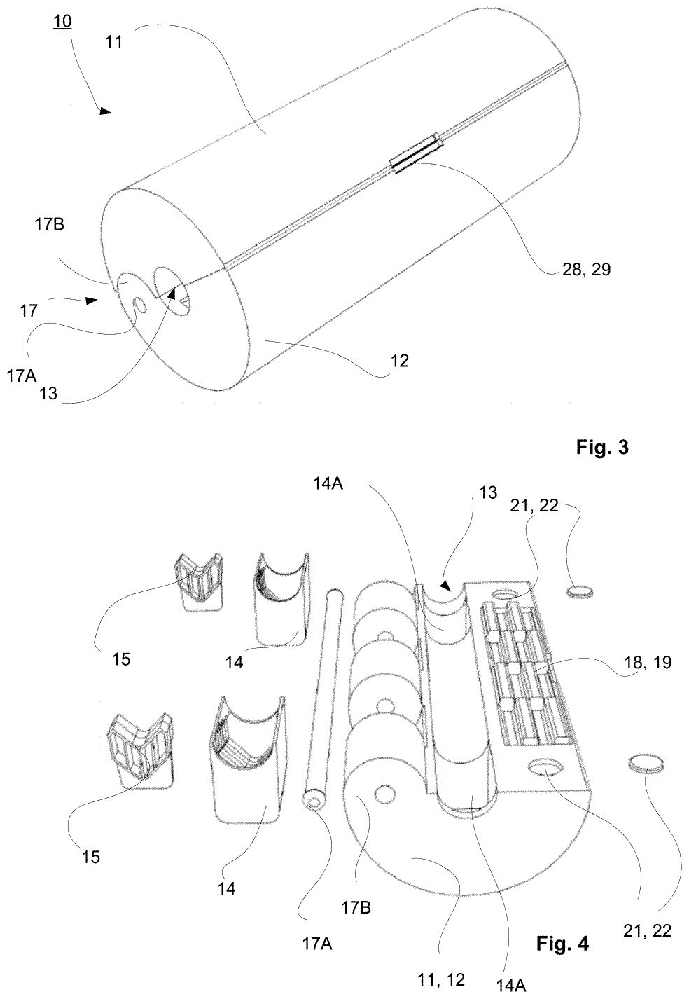

In FIG. 3 is schematically shown an advantageous example of FIGS. 1-2 as a 3D view, the roller in closed position.

In FIG. 4 is schematically shown the advantageous example of FIGS. 1-3 as an exploded view.

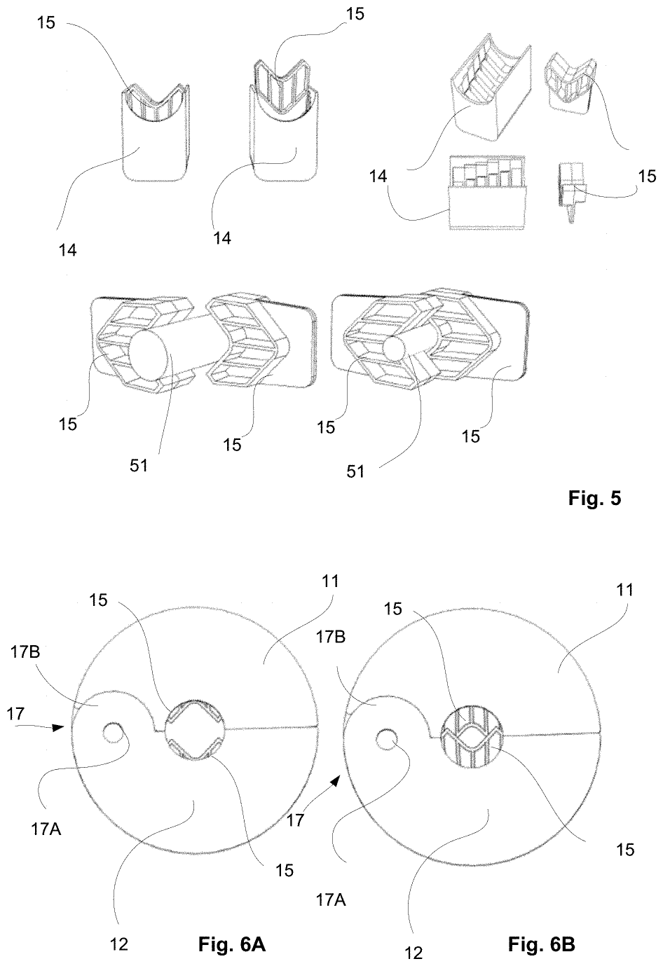

In FIG. 5 is schematically shown an advantageous example of adjusting rotation elements of the advantageous example of FIGS. 1-4 an exploded view.

In FIGS. 6A-6B is schematically shown the advantageous example of FIGS. 1-3 as end views with adjusting rotation elements in different positions.

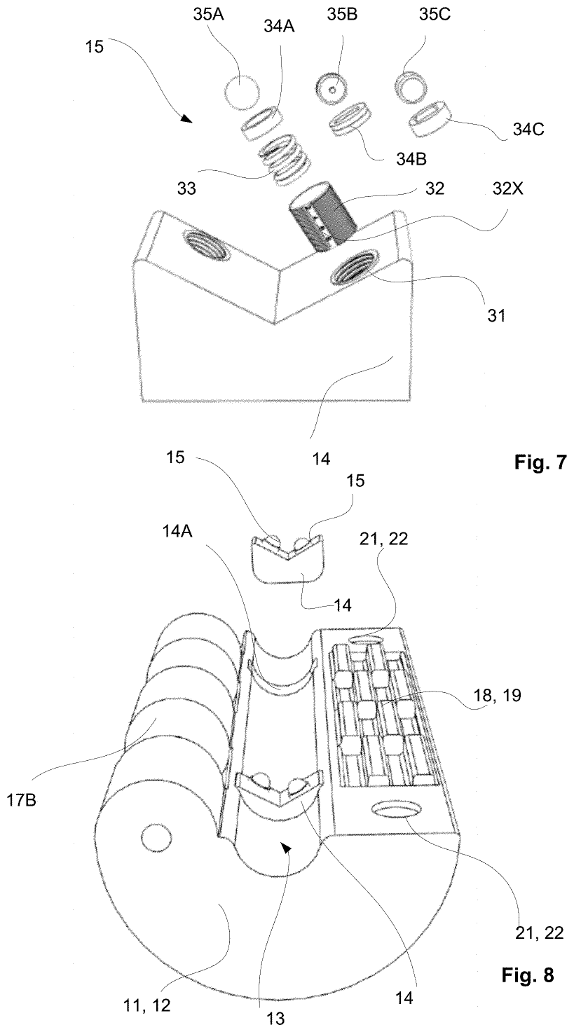

In FIG. 7 is schematically shown another advantageous of adjusting rotation elements of an advantageous example of a fitness, exercise and massage roller.

In FIG. 8 is schematically shown the advantageous example of adjusting rotation elements of FIG. 7 as a 3D assembly view to one frame part of the roller.

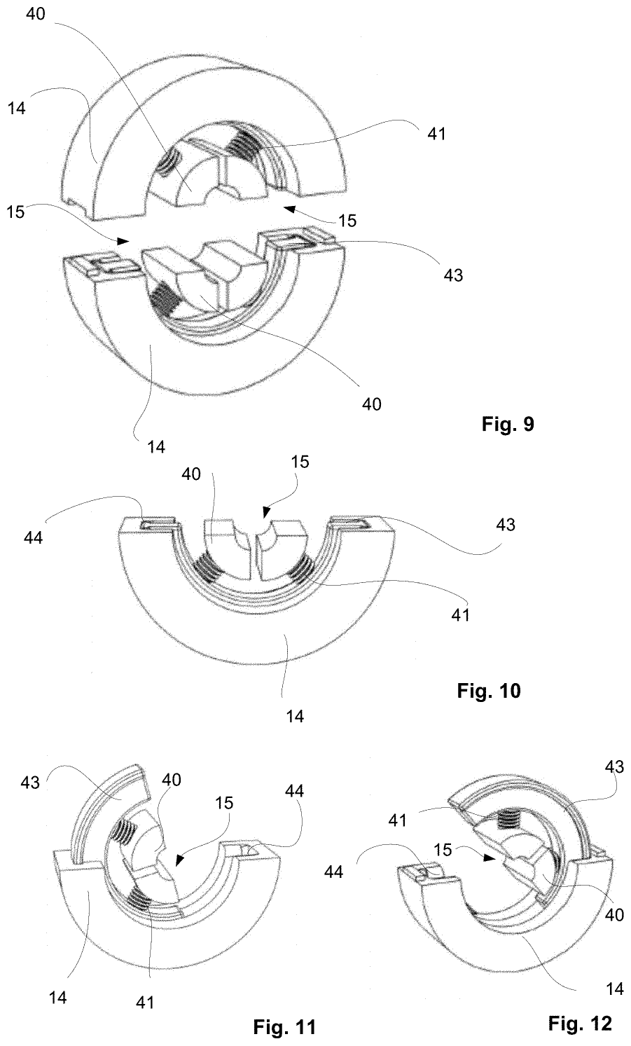

In FIGS. 9-12 is schematically shown is schematically shown yet another advantageous of adjusting rotation elements of an advantageous example of a fitness, exercise and massage roller.

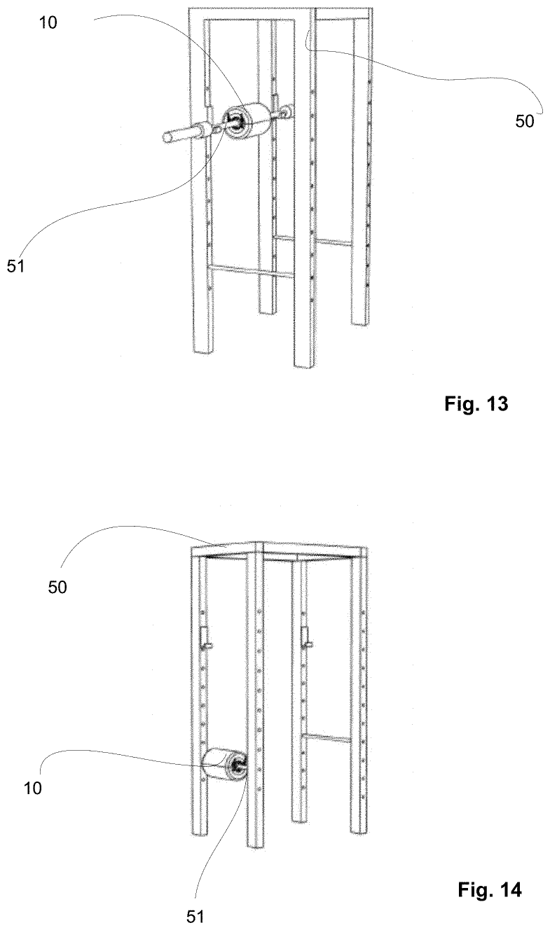

In FIGS. 13-14 is schematically shown advantageous examples of the fitness, exercise and massage roller fastened on a bar-type support of a frame.

### DETAILED DESCRIPTION

During the course of the following description like numbers and signs will be used to identify like elements according to the different views which illustrate the invention and its advantageous examples. In the figures some repetitive reference signs may have been omitted for clarity reasons.

In the description of the figures the terms upper and lower, as well as terms horizontal and vertical are used in view of normal use position of the fitness, exercise and massage roller. The terms front and back are used in view of the normal position of the user in the fitness, exercise and massage roller.

In the figures is shown examples of a fitness, exercise and massage roller 10 (in the following “roller”), which has an outer cylindrical form and a hollow opening 13 around its imaginary center axis. The roller 10 comprises two frame parts 11, 12, which are semicircular in their outer form and comprise recesses that form the hollow opening 13. The frame parts 11, 12 are advantageously substantially identical and symmetrical, as well as formed in a way that they fit to each other when aligned to form a full cylindrical form. Thus, the frame parts 11, 12 can be produced by one mold.

The frame parts 11, 12 are attached turnably to each other on one longitudinal side by at least one hinge 17 such, that the frame parts 11, 12 are turnable towards or away from each other providing the opening and closing of the roller 10. The hinge 17 is formed of hinge structures 17B formed on the frame parts 11,12 and are hinged with a hinge axis 17A through holes of the hinge structures 17B formed on the frame parts 11, 12.

The roller 10 further comprises locking means 21, 22 for securing the closed position of the frame parts 11, 12 of the roller 10. The locking mechanism 21, 22 are advantageously located at least at one end or side or opposing inside faces of frame parts 11,12 of the roller 10. In case the hinge 17 has a high spring-back factor the locking mechanism 21, 22 can be omitted.

The roller 10 also comprises on each frame part 11, 12 recesses 28, 29 on opposite longitudinal side in relation to the hinge 17 providing an opening point of the frame parts 11, 12 for easy turning of the frame parts 11, 12 away from each other around the hinge 17 by gripping with fingers after the locking mechanism 21, 22 have been opened.

The roller also comprises adjusting rotation elements 15, which will be located around the bar 51 or like, when setting the roller 10 for use. The adjusting rotation element 15 is located in and supported by a wall element 14, which wall element 14 in turn is supported to the corresponding frame part 11, 12. The adjusting rotation elements 15 are movable in radial direction i.e. in perpendicular direction in relation to the surface of the wall elements 14 and to the surface of the hollow opening 13 to adjust the roller 10 for bars 51 or like with different diameters. When the roller 10 is set around a bar 51, the roller 10 with the frame parts 11, 12 in opened position is set at the selected location at the bar 51. Then, the frame parts 11, 12 are turned to closed position around the hinge 17 such, that the bar 51 inside the hollow opening 13 is centered as the adjusting rotation elements 15 will set to the corresponding radial position around the bar 51. In case the adjusting rotation elements 15 are manually adjustable for setting the roller 10 around the bar 51, while the frame parts 11, 12 of the roller 10 are in opened position, the adjusting rotation elements 15 are set to desired radial position such, that the bar 51 inside the hollow opening 13 will be centered as the radial position of the adjusting rotation elements 15 will set the roller 10 to the corresponding radial position around the bar 51 and the roller 10 is set at the selected location at the bar 51. Then, the frame parts 11, 12 are turned to closed position around the hinge 17. The locking mechanism 21, 22 are locked and thus the roller 10 is rotatably around the bar positioned at its place. When the roller 10 is to be removed the locking mechanism 21, 22 are opened and the frame parts 11, 12 are turned around the hinge 17 away from each other by gripping to the recesses 28, 29 and then, the roller 10 can be taken to a new position. The meeting surfaces of the frame parts 11, 12 also comprise a groove-protrusion fitting 18, 19 for preventing sliding of the frame parts in respect of each other.

The roller 10 comprises advantageously around its outer circumferential surface a padding of elastic material. The hardness of the padding can be selected for example in view of the desired usage. The outer circumferential surface of the roller 10 can be smooth or shaped. The padding and/or directly the outer circumferential surface of the roller 10 can be shaped. It can be for example be shaped with different shapes of different heights and have a ball-like, a serrated etc. profile.

The wall elements 14 of the roller 10 are advantageously of hard, supporting material, for example plastic material. The frame parts 11, 12 of the roller 10 are advantageously of slightly elastic or foamy plastic material.

The adjusting rotation elements 15 can be constructed of different types of bearings, ball bearings, annular ball bearing, circumferential bearing, sliding bearing, wheels etc. and comprises moving mechanism configured to provide the radial, adaptive movement of the adjusting rotation elements 15 for adapting the fastening of the roller 10 around bars of different sizes and cross-sectional shapes. The moving mechanism i.e. height adjustment mechanism can be for example based on staggered shapes, fitting pieces, springs or turnable threads. The adjusting rotation elements 15 are mounted inside the roller 10 at selected longitudinal locations, spaced apart such, that centering and adaptation of the roller 10 around the bar is provided. Advantageously, in longitudinal direction there is at least two adjusting elements in each frame part 11, 12. The adjusting rotation elements 15 may also comprise for example a brake mechanism for adjusting the rotational resistance for providing different exercise effect.

In FIGS. 1-6B is shown an example of the adjusting rotation elements 15 mounted in element recesses 14A of the hollow opening 13 of the roller 10. In FIGS. 1-2 the element recesses 14A are formed in the frame parts 11, 12 and thus, the adjusting rotation elements 15 are mounted directly in the element recesses 14A of the frame parts 11,12 in the hollow opening 13 of the roller 10. In FIGS. 3-6B wall elements 14 are provided and the adjusting rotation elements 15 are mounted on the wall elements 14, which are located in the element recesses 14A of the frame parts 11, 12 in the hollow opening 13 of the roller 10. The innermost surface of the adjusting rotation element 15 is a sliding joint and the individual sliding joint is constructed in an angle to provide at least two centering contact points to the bar 51 or like and for providing rotational movement of the roller 10 around the bar or like for use. The outermost part of the rotation element is formed to make a stabile fit with the staggered openings formed on the wall element 14 (FIGS. 3-6B) and by placing the adjusting rotation elements 15 to different openings of the wall elements 14 for adjusting the cross-sectional dimensions of the hollow opening 13 to the cross-sectional dimension of the bar or like around which the roller 10 is to be placed for use. The staggered openings can be formed also straight to the frame parts 11,12 (FIGS. 1-2), when the wall element 14 is not needed.

In FIGS. 7-8 is shown another example of the adjusting rotation elements 15 mounted on the wall element 14 in element recesses 14A of the frame parts 11, 12 in the hollow opening 13 of the roller 10. The adjusting rotation elements 15 comprises a ball 35A, which can be replaced in other examples for example by a wheel 35B or by a ring 35C. The ball 35A is supported by a ball race 34A. The wheel 35B or the ring 35C is correspondingly supported on a wheel race 34B, on a ring race 34C. The ball 35 and the ball race 34, correspondingly the wheel and the ring 35B, 35C and the wheel and the ring race 34B, 34C, thus form an adjusting rotation element 15 for providing rotational movement of the roller 10 around the bar 51 or like for use. A sleeve 32 is by a threading joint attached to a corresponding opening 31 in the wall element 14. By the threading joint the height position of the ball 35A, correspondingly, the height position of the wheel 35B, the height position of the ring 35C can be adjusted by adjusting the cross-sectional dimension of the hollow opening 13 to the cross-sectional dimension of the bar 51 or like around which the roller 10 is to be placed for use. The adjusting rotation element 15 may also comprise a spring 33 configured to provide a self/auto adjusting mechanism for the cross-sectional dimensions of the hollow opening 13 to the cross-sectional dimension of the bar 51 or like around which the roller 10 is to be placed for use. In connection with the adjusting rotation element/-s 15 a scale 32X may be provided indicating the amount of adjustment. In this example the scale 32X is provided in connection with the sleeve 32. The scale 32X showing the placement of the sleeve 32 and thus indicating the amount of the adjustment.

In FIGS. 9-12 is shown another example of the adjusting rotation element 15 mounted on the wall element 14 to be positioned in the element recesses 14A of the frame parts 11, 12 in the hollow opening 13 of the roller 10. The adjusting rotation elements 15 are movable in radial direction i.e. in perpendicular direction in relation to the surface of the wall element 14. The adjusting rotation element 15 comprises a leg 40, which is positioned by the threading joint 41 to the desired dimensional position to achieve a firm grip around the bar 51 when locked and such, that the bar 51 inside the hollow opening 13 is centered as the adjusting rotation elements 15 are to the corresponding radial position around the bar 51. Adjustment can be done by manually turning the legs 40 in the threads 41 or auto-/self-adjusted by springs. The leg 40 and the thread 41 are in connection with an inner sliding joint part 43, which rotatably moves in the groove 44 that is formed in the wall element 14. When the roller 10 is closed and locked, the rotatably sliding joint 43 and the groove 44 form a full circle and the form in the ends of the sliding joint part 43 and in the ends of the groove 44 guides the sliding joint part 43 smoothly from the top part to bottom parts (and vice versa) of the groove 44 of the wall elements 14 allowing smooth and firm rotation of the roller 10 around the bar 51 or like. The threads 41 can include a spring or corresponding element for self/auto adjusting mechanism for adjustment of the cross-sectional dimensions of the hollow opening 13 to the cross-sectional dimension of the bar 51 or like around which the roller 10 is to be placed for use.

In FIGS. 13-14 the fitness, exercise and massage roller 10 is fastened on a bar-type support i.e. a bar 51 of a frame 50. The fitness, exercise and massage roller 10 is fastenable around the bar 51 or like without need of releasing the bar 51 from its frame 50 or of opening the bar 51 or dismantling it to parts. The fitness, exercise and massage roller 10 comprises the mechanism configured to provide rotatable and adjustable fastening of the roller 10 around the bar 51. The mechanism is constructed as the adjusting rotation elements 15 configured to adjust or self-adjust cross-sectional inner dimensions of the hollow opening 13 around center axis of the roller 10 to outer dimensions of cross-section of the bar 51 such, that the roller 10 rotates smoothly around the bar 51 irrespective of outer dimensions and/or cross-sectional shape of the bar 51. The fitness, exercise and massage roller 10 comprises an openable mechanism constructed as the locking mechanism 21, 22 configured to provide easy fastening of the roller 10. The adjusting rotation elements 15 are configured to provide the rotating of the roller 10 around the bar 51 or like and comprise a ring/-s, a wheel/-s, a bearing/-s, a roll/-s, a slip joint/-s or a combination of these. The ring/-s, the wheel/-s, the bearing/-s, the roll/-s, the slip joint/-s or the combination of these in the adjusting rotation elements 15 can directly contact the bar 51, whereby the rotating movement is provided between the ring/-s, the wheel/-s, the bearing/-s, the roll/-s, the slip joint/-s or the combination of these and the bar. Alternatively, the ring/-s, the wheel/-s, the bearing/-s, the roll/-s, the slip joint/-s or the combination of these in the adjusting rotation elements 15 can be located inside the roller structure, whereby the roller 10 is fastened non-movably around the bar 51 and the rotating movement is provided in the wall elements 14 of the roller 10. The wall elements 14 comprise in its structure a joint or a bearing to provide the rotating movement. The adjusting rotation elements 15 may comprise a brake mechanism, whereby resistance can be provided to the rotating movement of the roller 10. In connection with the adjusting rotation element/-s 15 a scale 32X may be provided indicating the amount of adjustment. The adjusting rotation elements 15 can be automatically adjustable, self-adjusting, or manually adjustable around the bars 51 or like with different cross-sectional dimensions, for example diameters of 10-50 mm. The adjusting rotation elements 15 may comprise a spring/-s, an adjustment screw/-s, an adjustment latch/-es, a clamp/-s, a tension string/-s, staggered shapes and/or an adjustment piece/-s.

The fitness, exercise and massage roller 10 is configured to be fastened around the bar 51 or like by first opening the roller 10 by separating from each other at least two cylindrical segments, the frame parts 11, 12, of the roller 10. The opening may be provided by a hinge mechanism 17 or by releasing one or more cylindrical segments from the roller by releasing the fastening, for example a pin mounting, between them or by opening a hatch of the roller or through an opening, for example a spiral opening of the roller. The fitness, exercise and massage roller 10, thus may comprises at least one hinge mechanism 17, which may be constructed in frame parts or may be of hard material, such as hard plastic or metal, or is a spring hinge or is made of elastic material, for example of leather or of elastomer. The fitness, exercise and massage roller 10 advantageously comprises at least one locking mechanism 21, 22, for example an adjustable latch lock/-s, a clamp/-s, a magnet/-s, a Velcro/-s or a tension string/-s, by which the roller is fastened securely and safely around the bar or like.

In the description in the foregoing, although some functions and elements have been described with reference to certain features and examples, those functions and elements may be performable by other features and examples whether described or not. Although features have been described with reference to certain embodiments or examples, those features may also be present in other embodiments or examples whether described or not.

Above only some advantageous examples of the inventions have been described to which examples the invention is not to be narrowly limited and many modifications and alterations are possible within the invention.

1. Fitness, exercise and massage roller, which roller (10) has a substantially cylindrical shape and a hollow opening (13) around its imaginary center axis, which roller (10) comprises two or more frame parts (11,12), which are at least part-circular in their outer form and configured to form the cylindrical shape of the roller (10), characterized in that at least one of the frame elements (11, 12) is separable or turnable from connection with the other frame elements (11, 12) such, that a longitudinal opening is formed and that the roller (10) is configured to be located around a bar (51) or like via the longitudinal opening and that the roller (10) comprises adjusting rotation elements (15) located in the hollow opening (13) and configured to provide rotatable and adjustable fastening of the roller (10) around the bar (51) or like and that the adjusting rotation elements (15) are configured to adjust or self/auto-adjust cross-sectional inner dimensions of the hollow opening (13) to correspond to cross-sectional outer dimensions of the bar (51).

2. Fitness, exercise and massage roller according to claim 1, characterized in that adjusting rotation element (15) is mounted in element recesses (14A) of the frame parts (11,12) in the hollow opening (13) of the roller (10).

3. Fitness, exercise and massage roller according to claim 1, characterized in that adjusting rotation element (15) is mounted in a wall element (14) in the element recesses (14A) of the frame parts (11,12) hollow opening (13) of the roller (10).

4. Fitness, exercise and massage roller according to claim 1, characterized in that innermost surface of the adjusting rotation element (15) is a sliding joint constructed in an angle to provide at least two centering contact points to the bar (51) or like and configured to provide rotational movement of the roller (10) around the bar (51) or like for use.

5. Fitness, exercise and massage roller according to claim 1, characterized in that outermost part of the adjusting rotation element (15) is formed to make a stabile fit with staggered openings formed on the wall element (14) and/or on the element recesses (14A) and by placing the adjusting rotation elements (15) to different openings of the wall elements (14) and/or on the element recesses (14A) for adjusting the cross-sectional dimensions of the hollow opening (13) to correspond to the cross-sectional dimension of the bar (51) or like around which the roller (10) is to be placed for use.

6. Fitness, exercise and massage roller according to claim 1, characterized in that the adjusting rotation element (15) comprises a ball (35A); a ring (35B), a wheel (35C), a bearing, a roll a slip joint or a combination of these configured to provide the rotating movement of the roller (10) around the bar (51).

7. Fitness, exercise and massage roller according to claim 6, characterized in that the ring/-s, the wheel/-s, the bearing/-s, the roll/-s, the slip joint/-s or the combination of these in the adjusting rotation elements (15) is directly in contact with the bar (51) such, that the rotating movement is provided between the ring/-s, the wheel/-s, the bearing/-s, the roll/-s, the slip joint/-s or the combination of these and the bar (51).

8. Fitness, exercise and massage roller according to claim 1, characterized in that the ring/-s, the wheel/-s, the bearing/-s, the roll/-s, the slip joint/-s or the combination of these in the adjusting rotation elements (15) is located inside the roller (10) such, that the adjustment element (15) of the roller (10) is fastened non-movably around the bar (51) and the rotating movement is provided between the ring/-s, the wheel/-s, the bearing/-s, the roll/-s, the slip joint/-s or the combination of these and wall elements (14) of the roller (10).

9. Fitness, exercise and massage roller according to claim 1, characterized in that the adjusting rotation elements (15) are automatically adjustable, self-adjusting, or manually adjustable to provide the cross-sectional dimensions of the hollow opening (13) to provide the fastening of the roller around the bar (51).

10. Fitness, exercise and massage roller according to claim 1, characterized in that the adjusting rotation elements (15) comprise a spring/-s, an adjustment screw/-s, an adjustment latch/-es, a clamp/-s, a tension string/-s, and/or an adjustment piece/-s.

11. Fitness, exercise and massage roller according to claim 1, characterized in that the roller (10) further comprises locking mechanism (21, 22) for securing the closed position of the frame parts (11, 12) the roller (10).

12. Fitness, exercise and massage roller according to claim 1, characterized in that the roller (10) comprises at least one hinge (17) connecting at least two frame parts (11, 12) turnably to each other at one longitudinal side, and that the hinge is advantageously a spring hinge or is advantageously made of elastic material, for example of leather or of elastomer or the hinge (17) is advantageously formed of hinge structures (17B) formed on the frame parts (11, 12), which hinge structures (17B) are hinged with a hinge axis (17A) through holes of the hinge structures (17B) formed on the frame parts (11,12).

13. Fitness, exercise and massage roller according to claim 1, characterized in that the frame parts (11, 12) are substantially identical and symmetrical, that the frame parts (11, 12) formed such, that they fit to each other when aligned to form the cylindrical form.

14. Fitness, exercise and massage roller according to claim 1, characterized in that the roller (10) comprises on each frame part (11, 12) recesses (28, 29) on opposite longitudinal side in relation to the hinge (17) configured to provide an opening point of the frame parts (11, 12).

15. Fitness, exercise and massage roller according to claim 1, characterized in that meeting surfaces of the frame parts (11, 12) comprise a groove-protrusion fitting (18, 19) configured to prevent sliding of the frame parts (11, 12) in respect of each other.

16. Fitness, exercise and massage roller according to claim 1, characterized in that the roller (10) comprises a scale (32X) indicating the amount of adjustment provided by the adjusting rotation elements (15).
